(19) United States
(12) Patent Application Publication
(10) Pub. No.: US 2015/0022329 A1
(43) Pub. Date: Jan. 22, 2015

(54) Assisted Animal Communication

(71) Applicant: Forget You Not, LLC, Waban, MA (US)

(72) Inventors: Nissim Shani, Waban, MA (US); Daniel Shani, Waban, MA (US); Roni Shani, Waban, MA (US)

(21) Appl. No.: 13/943,391

(22) Filed: Jul. 16, 2013

(51) Int. Cl. G08B 3/00

(52) U.S. Cl. CPC G08B 3/00
USPC 340/286.01

(57) ABSTRACT

Artifacts of a communication are received from an animal through interface features of one or more devices. The artifacts are interpreted by computer to derive an interpreted communication represented by the artifacts.

### BACKGROUND

This description relates to assisted animal communication.

Dogs and cats, for example, are capable of a limited amount (compared to humans) of communication with human beings, and with other animals. Dogs and cats can make sounds and engage in motions that are believed to communicate their wishes, needs, reactions, and feelings.

In addition, they are believed to be capable of interpreting sounds, fragrances, odors, images, scenes, motions, and other stimuli as communications to them. This limited communication ability can form the basis of strong bonds, among other things. The love of pet owners for their pets and of the pets for their owners is well-known.

Electronic devices such as sound systems, televisions, and display monitors attached to computers can be used to play audio and video material that may be considered entertaining for pets.

### SUMMARY

In general, in an aspect, artifacts of a communication are received from an animal through interface features of one or more devices. The artifacts are interpreted by computer to derive an interpreted communication represented by the artifacts.

Implementations may include one or any combination or two or more of the following features. Receiving the artifacts of the communication includes detecting at least one of a noise or motion of the animal. Interpreting the artifacts includes comparing the artifacts to known examples of similar artifacts. Interpreting the artifacts is done at a server. Interpreting the artifacts is done at a client device. Interpreting the artifacts includes using information provided by a human being about the animal or about artifacts that may be produced by the animal. The interpreted communication is presented to a human being. The animal and the human are at different locations. The animal is a pet and the human is the pet's owner. The interpreted communication is presented to the human being through a user interface of the device.

In general, and an aspect, a communication from a human to an animal is received through interface features of one or more devices. The communication is articulated by computer as artifacts that will represent the communication when presented to the animal. The communication is expressed in a form that is understandable by humans but not understandable by an animal. The communication is received as text or speech from the human. The one or more devices include a mobile device. The communication is articulated as the artifacts based on information provided by humans about the relationship of the communication to the artifacts. They artifacts are caused to be presented to the animal. The artifacts are caused to be presented to the animal by interface features of one or more devices. The artifacts are caused to be presented to the animal by sending them through a network to one or more devices located with the animal. The human and the animal are in different locations.

In general, in an aspect, at a server, artifacts are received from one or more client devices of communications of animals through interface features of one or more devices. Information is sent from the server to one or more client devices, information that enables the one or more client devices to convey the communications to human beings.

These and other aspects, features, and implementations, and combinations of any two or more of them, can be expressed as methods, apparatus, systems, components, methods of doing business, program products, and means and steps for performing functions, and in other ways.

These and other aspects, features, and implementations will become apparent from the following description, and from the claims.

### DESCRIPTION

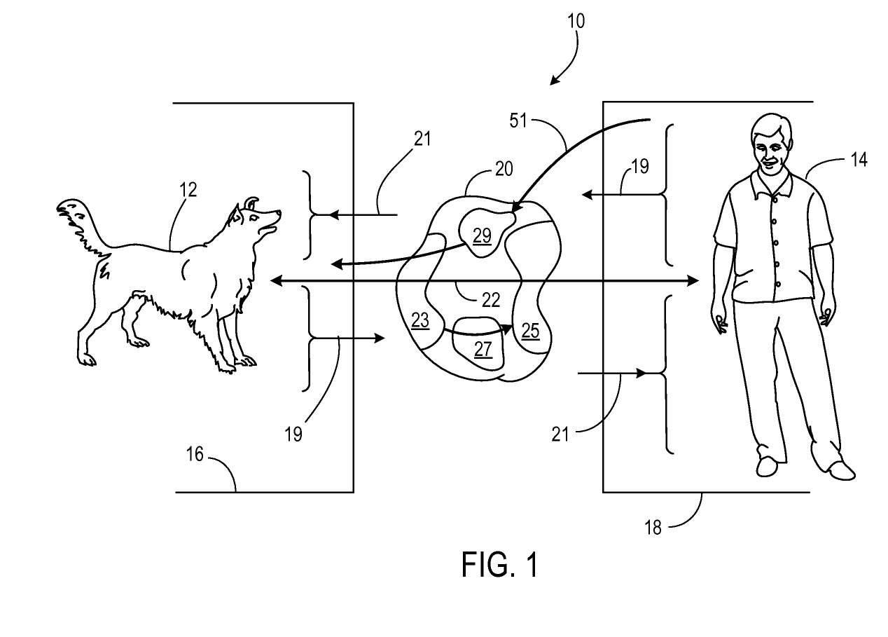

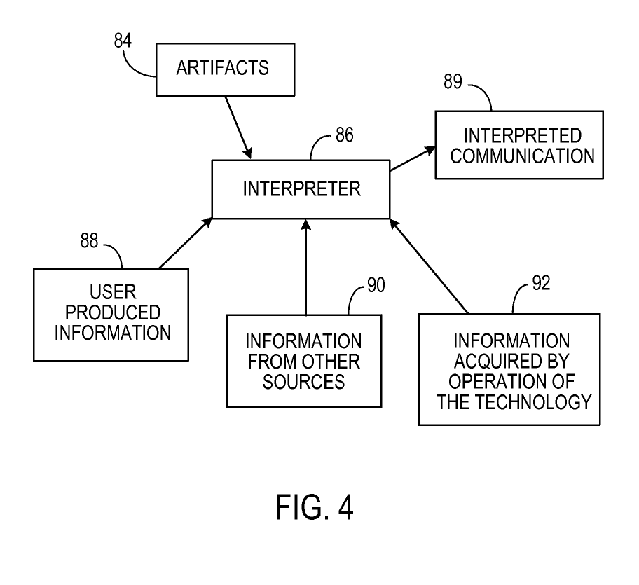

FIGS. 1 through 5 are block diagrams.

As shown in FIG. 1, in some implementations of what we describe here, assisted animal communication 10 includes communication between an animal 12 and a human 14, for example, a dog or cat and its owner. In some cases, we describe examples in which the animal and the human are not in the same place or cannot otherwise see or hear each other and therefore cannot communicate directly, for example, when the dog is at home 16 and the owner is at work 18. We describe examples of technology-based systems and techniques (together, technology) 20 that assist the dog to communicate with the owner and vice versa 22 in such circumstances. The technology that we describe here, however, can be useful to assist communication also when the animal and human are located in the same place or can see or hear each other directly.

We use the term animal broadly to include, for example, non-human animals of any kind that are capable of some degree of communication, including primates, dogs, cats, other mammals, and pets, to name a few. We use the term communication broadly to include, for example, any conveying or comprehension of information, emotions, thoughts, or actions between a human and an animal by any mechanism, device, or capability (which we will sometimes refer to as artifacts of communication) including any respect in which the human or animal can move, act, behave, make noise, or otherwise affect its environment (we sometimes refer to these as produced artifacts of communication 19) and any respect in which the human or animal can hear, see, taste, smell, touch, or otherwise sense its environment (we sometimes refer to these as sensed artifacts of communication 21). Produced artifacts and sensed artifacts can relate to voice, sound, image, motion, activity, fragrance, odor, stimuli, and others, and combinations of them. We use the term assisted broadly to include, for example, any device or method that aids, supplements, processes, accelerates, and in any other way helps or enhances the conveying of information, emotions, thoughts, or actions between a human and an animal. We use the term technology broadly to include, for example, any mechanical, electrical, computer, network, wireless, and other devices and techniques, or combinations of them.

We use the term artifacts of communication broadly to include, for example, any sound, noise, image, motion, odor, fragrance, vibration, action, or other activity, stimulus, or event of any kind, to name a few, that is part of, represents, or could be interpreted or understood with respect to a communication.

Communication between an animal (say, a dog Fluffy) and a human (say, Fluffy's owner, George) generally requires that the communication by Fluffy or George be expressed as produced artifacts that represent the communication (Fluffy barks in a certain way, or George snaps his fingers in a certain way), that sensed artifacts that correspond to the produced artifacts be received (George hears the barking, or Fluffy hears and sees the finger snapping), and that the recipient of the communication be able to understand the communication in a way that the source of the communication intended (George understands that Fluffy wants to go outside, or Fluffy understands that George wants Fluffy to come to him).

The source of the communication can vary the characteristics of produced artifacts of the communication (such as the volume, duration, frequency, pitch, and style of Fluffy's barking) to impart meaning that, by experience, seems to be understood by the recipient (Fluffy has learned that a certain kind of barking will communicate to George that Fluffy wants to go outside). In some cases, the produced artifacts can be interpreted using speech recognition or recognition of sounds made by animals. The recipient of the communication can interpret the characteristics of the received artifacts as indicating the nature of the communication (George has learned, by experience, that a certain kind of barking by Fluffy means she wants to go outside). Thus there is a process by which the sender of the communication learns to formulate the artifacts to represent the communication so that it will be understood effectively and the recipient learns to interpret the correct meaning of the communication represented by the artifacts.

In direct communication between an animal and a human, for example, a pet and its owner, the ability to formulate the produced artifacts effectively and the ability to correctly interpret the sensed artifacts develops over time, sometimes subconsciously and sometimes through training, for example.

The technology that we describe here can assist animal communication in a wide variety of ways. In some implementations, the technology assists animal communication by providing a store-and-forward function for produced artifacts. The technology can include devices 23, 25 that receive, sense, or capture the produced artifacts of communication from the sender and reproduce and deliver versions of the artifacts to the recipient for whom they become sensed artifacts. For example a microphone (one of the devices 23) at the place where Fluffy is located can pick up her barking. In a simple example, the barking can then be delivered through a speaker (one of the devices 25) at the place where George is located (even at the same place where Fluffy is located, in some examples). In some cases, the received artifacts can be passed through artifact processing devices 27 and the process artifacts can then be delivered to the recipient by devices 25. Artifact processing devices 27 can include any kind of device that is capable of receiving, storing, analyzing, altering, enhancing, processing, and sending information about artifacts. In some instances, artifacts can be retransmitted through a network to pass them to the recipient located at a different location than the sender. In some cases, artifacts can be stored temporarily or for an extended period of time and then retransmitted to the recipient. For example, video and text derived from or related to the video or a picture and a message derived from or related to the picture can be delivered to a recipient, either the human or the animal.

For example, Fluffy's barking at 8 AM at his home in Marblehead, Mass., can be recorded, processed to enhance the quality of the recording, and then stored. Later, when George wakes up at 8 AM on his business trip to Palo Alto, Calif., the technology can deliver the sound to George's cell phone at his hotel room.

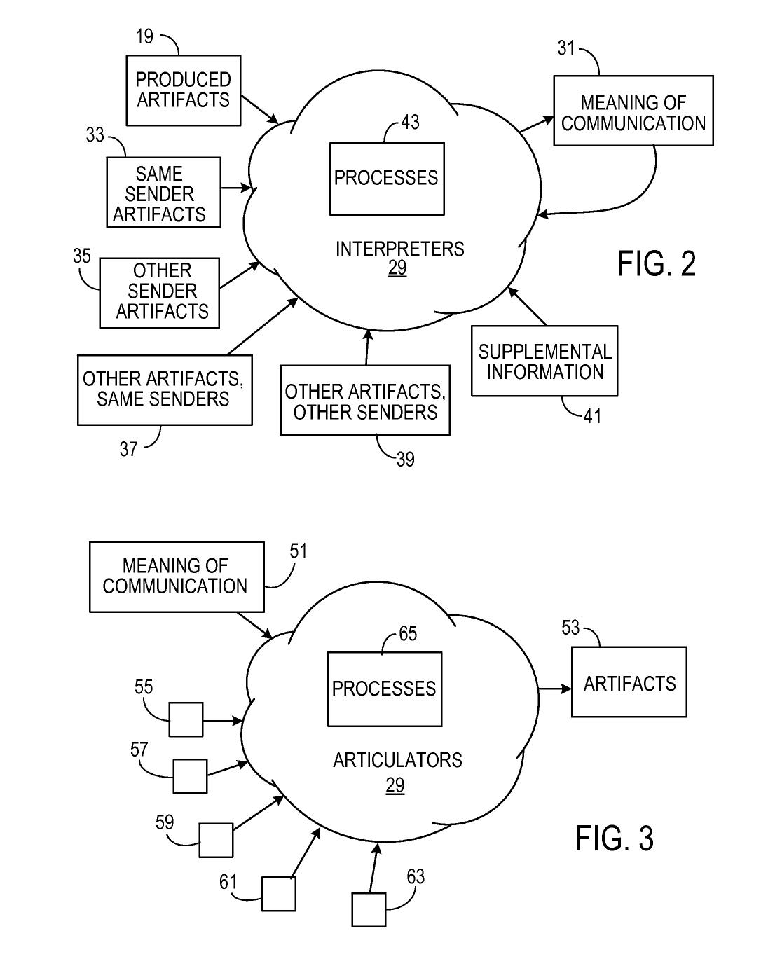

In some examples, as shown in FIG. 2, the artifact processing devices 27 can include interpreters 29 that convert, interpret, translate, or otherwise derive the meaning of the communication 31 represented by received artifacts, based on information available to the processing devices. The information available to the processing devices can include the produced artifacts 19, previously produced artifacts of the same sender 33 (for example recordings of Fluffy barking when she wanted to go outside), previously produced artifacts of other senders 35 (for example, recordings of other dogs barking when they want to go outside, or videos of a large number of dogs engaging in various kinds of behavior, such as barking, pacing, and running), other produced artifacts of the same sender 37 (for example, videos of Fluffy tapping her paw against the door when she wants to go outside), other produced artifacts of other senders 39 (for example, videos of other dogs tapping their paws against doors when they want to go outside), supplemental information 41 provided by human beings about the behavior of the sender (for example, information provided by George that Fluffy barks and taps her paws against the door when she wants to go outside, and that she typically wants to go outdoors between 1 PM and 3 PM every afternoon), data about the context of the produced artifacts 19 such as the time when Fluffy was barking, how recently she was barking on the previous occasion, where Fluffy is located at the moment, and a wide variety of other information.

Users of the technology 20 (for example owners of pets) can provide some of the supplemental information 41 through interface features of client devices to define, explain, illustrate, or otherwise capture relationships between artifacts of communication and interpretations of the artifacts and between communications and artifacts that can be used to articulate them. For example, George could take videos of Fluffy pacing back and forth at times when Fluffy needs to be walked, submit the videos, and add the information that the videos represent Fluffy needing to be walked. In that case, the artifacts could be the pacing back and forth, the speed of pacing, the duration of pacing, the extent of pacing, and other characteristics, which can be reflected directly in the video or explicitly identified by text entry by the user. The corresponding interpreted communication would be that Fluffy needs to be walked. In some cases, George could add video and a voice overlay to the video indicating the meaning of what is shown in the video.

Later, during operation of the technology 20, when Fluffy is captured in a video pacing back and forth, the interpreter can use the previously entered video and other information as the basis for interpreting the pacing as indicating that Fluffy needs to be walked, if the current pacing is found to match to some degree the previously provided pacing videos. To perform the analysis, the interpreter can use a variety of mathematical and statistical techniques and models. A wide variety of other kinds of information can be provided by a user such as information about the animal (size, age, species, favorite foods, and behavior, to name a few), information about the human, information about the environment in which the animal or the human is doing the communicating, and others. The supplemental information can include information about a class of animals to which the animal belongs, habits of that class of animals, behavioral patterns, and many others.

The technology 20 can generate its own information useful in later interpretation, for example, by storing information acquired through client devices and interface features during the operation of the technology, and by storing its analysis and interpretations of that information. For example, the technology 30 could acquire and store videos, images, audio recordings, text, and other information obtained from animals and humans, could associate artifacts of communication that occurred in those stored items with interpretations of the communications based on explicit confirmations provided by the humans based on inference, and could store artifacts that were used to correctly articulate communications, and combinations of those activities. The technology 20 can also embed the voice of the owner, or a picture of the owner and the voice of the owner that reflect interpretations of the content of the artifacts of communication

The interpreters 29 can include processes 43 that use the available information to derive the meaning of the communication 31. The processes can include algorithms, inference engines, models, and a wide variety of other mathematical, logical, and other processes, and combinations of them.

Once the meaning of the communication 31, represented by received artifacts, has been derived or determined by the interpreters 29, the meaning can be used in a wide variety of ways.

In some cases, the meaning can be conveyed to the recipient of the communication in a form different from the received artifacts. For example, if the interpreter determines that the meaning of certain behavior by Fluffy is that Fluffy wants to go outside, a text message or e-mail or alarm sound can be sent in text or some other form to a desktop computer at George's office to tell him that Fluffy wants to go outside. In some implementations, the meaning can be conveyed to the recipient at the same time as the artifacts (by playing back Fluffy's barking at the same time that the message is displayed to George, for example).

In some instances, the meaning of the communication can be saved in association with the artifacts that relate to the meaning The association between the meaning in the artifact can then be used by the interpreters 29 to improve the quality and speed of their interpretation of the meaning of other artifacts received from a sender.

In some implementations, the meaning of the communication can be used for a wide variety of purposes other than the direct delivery of the meaning to the recipient. For example, suppose that the meaning of a certain kind of barking done by Fluffy is that Fluffy wants to be fed a CrunchyLunch biscuit. The relationship of that meaning to the certain kind of barking might be aided by information provided by the manufacturer of CrunchyLunch biscuit based on prior associations with certain kinds of dog barking and its product. In addition, the manufacturer could make an arrangement to pay the host of the technology, each time the meaning of the communication has been determined as “feed me a CrunchyLunch biscuit”, to send a message to George saying “Fluffy wants to be fed a CrunchyLunch biscuit”. Or the manufacturer could pay the host of the technology to send an online coupon to buy CrunchyLunch biscuits for one dollar off the normal price of a box.

Some of the discussion above has described how artifacts can be interpreted as the meanings of communications from the source of the artifacts to a recipient. Conversely, as shown in FIG. 3, the technology can receive information about the meanings of communications 51 and select artifacts 53 that will express the communications to the intended recipients. For convenience, we call the part of the technology that performs this function “articulation devices” (or simply, articulators) 29 to capture the idea that the meaning is being articulated in artifacts so as to be understandable by the recipient. The articulators can use a wide variety of information, in addition to the meanings of communication, in determining which artifacts 53 to select. The additional information can include, for example, similar meanings of other communications of the same sender and related artifacts 55, similar meanings of other communications of other senders 57 and related artifacts, other meanings of other communications of the senders 59 and related artifacts, other meanings of other communications of other senders 61 and related artifacts, and supplemental information 63 provided by human beings.

For example, the supplemental information 63 could provide information that associates the meanings of communications with artifacts that could be useful in articulating those meanings. George could provide data to the technology explaining that when he wants to send a communication the meaning of which is “the door is open, you can now go outside”, he believes that Fluffy will be most responsive if the artifacts used to express that meaning include a certain video of him snapping his fingers. The artifacts can then be embodied in a video of George, recorded on his mobile phone, to be sent to Fluffy.

Conversely, artifacts derived from activities of Fluffy could be associated with meanings and the meanings could be articulated in the form of videos of Fluffy along with messages from Fluffy to George that articulate the meaning For example, certain artifacts of Fluffy's behavior may be interpreted by the technology as representing Fluffy attempting to communicate with George the message “I miss you. Won't you come home?” The technology could associate the artifacts of that communication. The communication can then be articulated in the form of a pre-recorded video of Fluffy that George would recognize as conveying the message, together with a caption on the video that says “I miss you want to come home?” The video message can then be sent to George on his mobile phone.

For the purpose of selecting the artifacts that should be used to convey a particular meaning of the communication, the articulators 29 can include processes 65 that use the available information to infer, derive, or determine the appropriate artifacts. The processes can include algorithms, inference engines, models, and a wide variety of other mathematical, logical, and other processes, and combinations of them.

For example, suppose that George has just awoken in the bedroom of his house and Fluffy is in the kitchen wanting to go outside through the dog door next to the slider that opens onto the deck. Suppose the dog door has an electronic switch that unlocks the door and a light that can be eliminated to tell Fluffy the door is now open and he can go outside. George hears Fluffy barking George picks up his cell phone, and launches the app provided by the technology, taps the option indicating that he wants to communicate to Fluffy by unlocking the dog door and turning on the light. The articulators, in this simple example, determine the meaning of the communication from George and then they select the best artifacts to articulate or express this communication to Fluffy. In this case, the technology sends the commands of the electronic switch on the dog door, to open the switch, and after the switch is open, turns on the light to tell Fluffy that the dog door is open.

In another example, suppose that the meaning of the communication is “try to interest Fluffy in asking for and eating a CrunchyLunch biscuit,” a communication that may have been received from the manufacturer of CrunchyLunch biscuits. The articulators consider the time of day, the room where Fluffy is located, information about whether Fluffy has eaten recently, and historical information about the susceptibility of Fluffy to the communication in that context. The articulators decide that the best way to motivate Fluffy is to show Fluffy a picture of a box of CrunchyLunch biscuits on a monitor in the living room where Fluffy is located, and to play the CrunchyLunch jingle on George's sound system in the living room. In addition, non-custom movies of the kind that are sometimes shown to pets could include advertising illustrating CrunchyLunch biscuits, playing the CrunchyLunch jingle, and in that way motivating Fluffy to become interested in eating CrunchyLunch biscuits.

A wide variety of games could be played with animals using the technology and with or without a human being present at the location where the game is being played. For example, a command (that can be set to be triggered at a particular time or after a series of other events or presentation of digital content) can indicate to the animal that the animal is to find a treat or toy that had been previously hidden by the owner somewhere near the television (or other source of artifacts) or at any location in the house. The repetition of this command (and “game”) will train the animal to search for the treat or toy and return to the TV. The ability of the technology through cameras or other sensors to recognize when the animal has found the treat or toy (using, for example, image recognition) can trigger the capture and delivery of an image of the dog to the owner and a message congratulating the animal on the accomplishment (“good dog, good dog”).

As suggested in this example, the technology could be used in a wide variety of ways to train animals remotely.

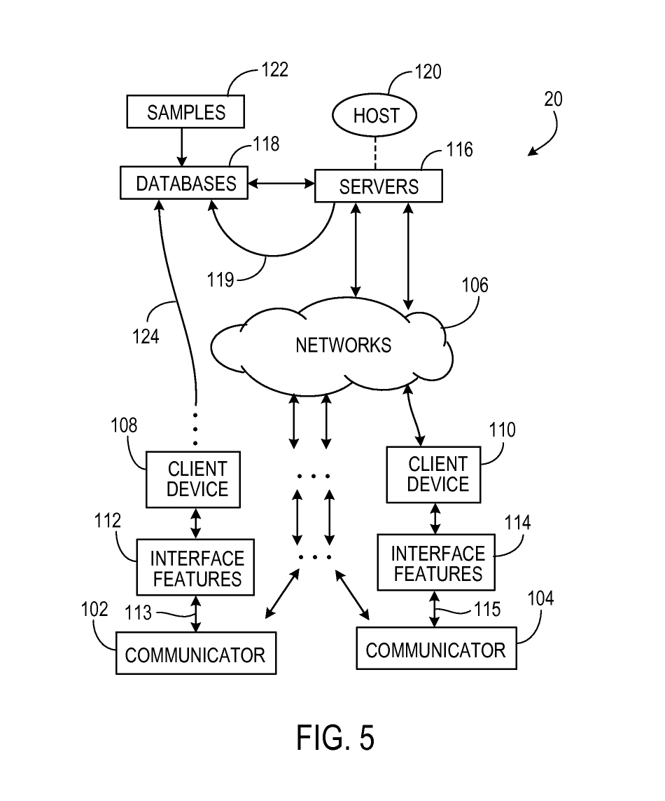

As shown in FIG. 5, the technology 20 can be implemented in devices and networks that assist communications between two or more communicators 100, 102 located anywhere in the world (for example, Fluffy and George). In some implementations, the technology 20 can be organized in a client-server model in which a host party 120 operates servers 116 that communicate through networks 106 with client devices 108, 110. The networks can be any kind of local or wide area networks, public networks, dial-up telephone networks, wireless or wired networks, cellular telephone networks, the Internet, Wi-Fi, or any other kind of communication network that can carry information related to assisting animal communication.

The client devices 108, 110, can internally include or externally support (or both) interface features 112, 114 (for example, the devices 23, 25 of FIG. 1) that enable interactions 113, 115, with animals and humans or other communicators 102, 104. Each of the client devices can be associated with one or more than one of the interface features. The interactions 113, 115 (for example the artifacts 19, 21 of FIG. 1) can include a wide range of interactions such as artifacts of communication produced by one of the communicators and sensed, detected, or received through the interface features; a wide range of noises, sounds, images, video, odors, tactile sensations, flavors, and other stimuli that serve as artifacts of communication to be received and used by one of the communicators; information provided by the communicators through user interfaces that are part of the interface features. With respect to the latter, for example, a communicator (a human or an animal) may be able to enter text, have speech recognized, have gestures recognized, touch user interface elements, and in a wide variety of other ways, to enter information through the interface features into the client devices. The entered information may relate to communications between two communicators or can relate to the setting up, management, and operation of the technology (for example, a user creating a user account with the technology).

In some cases, the servers 116 interact with the client devices to aid communications between communicators by having the servers send and receive information associated with the communications to and from the client devices. The client devices in turn aid communications between communicators by sending and receiving information to and from the interface features.

Various kinds of processing of the information can then need to occur within the technology 20. The processing can be divided in a wide variety of ways between the servers, the client devices, and the interface features. In some cases, the client devices may do very little other than pass information back and forth, while most of the processing effort is performed at the servers. In other cases, most of the processing could be done in the client devices with the servers simply passing processed information back and forth through the networks to and from the client devices. Other arrangements would also be possible.

The servers can be associated with databases 118 that contain a wide variety of information concerning the animals, the humans, the client devices, the interface features, behavioral information about animals and humans, information about communications, user files, account information, and others. The information for the databases can be provided 124 from the communicators in the form of any sort of artifacts of communications or information associated with communications or with users of the technology. Information for the databases can also be provided 119 from the servers based on processing of information that flows through the technology (for example, interpreted communications that are based on received artifacts can be stored for future use). Information can also be provided from external sources 122. For example, information about the behavior, actions, history, interests, and communications of specific animals or humans or of animals or humans in general or with respect to groups, types, species, or categories of them, to name a few, can be provided.

A broad range of software, firmware, hardware, or combinations of them, could serve as the client devices. The client devices could be, for example, any kind of device that is capable of providing or controlling or using the interactive features to conduct any of the interactions with any of the communicators and capable either directly or indirectly of communicating information with the servers.

The client devices can include, for example, computers, laptops, pad computers, mobile devices, mobile telephones, telephones, televisions, music systems, appropriately wired refrigerators, storage containers, doors or gates, pet houses, houses, automobiles, boats, kennels, and veterinary facilities to name a few.

The interface features can be provided through elements that are part of the client devices or by interface elements that are connected to, driven by, or controlled by the client devices. The interface features can include, for example, loud speakers, headphones, or other sound producing features, microphones or other sound detectors, GPS features, vibrational or other tactile features, displays, screens, projectors, or other image or video displaying features, fragrance generators, odor generators, fragrance detectors, odor detectors, cameras, video cameras, image detectors, and other audiovisual features, switches, latches, locks, lights, fans and other wind creating devices, sunscreens, shades, and a wide variety of other input and output elements that can provide or receive stimuli, information, and other artifacts of communication to and from the animals or humans.

In some instances, the interface features could be represented by an Internet browser running on a computer or handheld device or by a user interface provided by an app on a mobile phone or other handheld device.

Over a period of time, during the course of the operation and use of the technology, a wide variety of information including communications, messages, artifacts, events, behavior, and other aspects of the lives of animals and humans will be captured and stored. This information and parts of it can be used for a wide variety of purposes. For example, once a year, say on an anniversary of the first time George and Fluffy met, or on George's birthday, or Fluffy's birthday, or at other intervals or on other occasions, the technology could automatically (or upon request by George or Fluffy) aggregate from the stored information an album or a video or a greeting card or another kind of multimedia presentation to be played to George or Fluffy.

Unlike other facilities that may present non-custom sounds, audio, video, or images to a large number of different pets to entertain them, the technology can be used to present highly customized and therefore much more interesting presentations to humans and animals. For example, George could select the video of himself from the technology, add a selected picture of himself, and add selected icons or symbols that Fluffy would understand, and have an aggregated presentation using those content elements delivered to Fluffy at any time of the day or night on any day of the year. George could also create a multimedia presentation made up of artifacts received from Fluffy and other elements for presentation to himself or to others.

In some cases, the communications 22 between humans and animals that are assisted by the technology 20 can be simple and direct and require no interpretation. For example, Fluffy's barking in a certain way can be a produced artifact 19 of a communication that would be clearly understood by George without assistance or interpretation by the technology. In such a case, the interface features and client devices need only detect the artifact of Fluffy's communication and pass it through the networks to the server, which can then pass it back through the networks to other interface features and client devices associated with George. For example, a camera on a laptop computer in George's living room can capture video of Fluffy barking and the video can be passed to the server and then from the server to George's mobile phone. George may be able to understand what Fluffy is trying to communicate simply by watching the barking.

In some cases, the artifacts 19 of a communication that a human or animal is trying to provide to the other may require interpretation by the interpreters 29 before the content of the communication can be conveyed to the other. For example, the way in which Fluffy paces back and forth at a given time of the day may indicate that Fluffy needs to be walked. A video that captures Fluffy pacing could then be interpreted by the processes 43 as meaning that Fluffy needs to be walked. The interpreted communication 31 could then be provided to George through another client device.

Thus, the technology 20 can assist communication between a human and animal by (1) providing a simple conduit for passing, storing, and delivering artifacts of communication from one to the other, (2) interpreting artifacts of communication produced by one of them and passing, storing, and delivering the interpreted communication to the other, (3) receiving a communication from one of them and articulating artifacts that represent the communication, and delivering the artifacts to the other, or (4) any combination of two or more of those.

The interpretation of artifacts as a communication, the articulation of artifacts based on a communication, or a combination of them, can be done by a wide variety of hardware, firmware, or software running on a wide variety of devices of the technology 20. In some implementations, the artifacts or communications are passed to the server and the interpretation and articulation are done at the server. In some implementations, the artifacts are interpreted or the communications articulated at the client devices and the interpreted communications or the articulated artifacts are passed to the server. In some cases, some of the processing can be done at client devices and some of the processing can be done at the server.

The databases associated with the server (and similar databases or portions of them associated with the client devices) can store a wide variety of different kinds of information useful in the operation of the technology 20. For example, users of the technology can register account information about themselves and about animals, such as their pets. The information can be updated from time to time and stored in user accounts.

A wide variety of information can be registered with the technology. For example, George could identify on an online mapping system, such as Google maps, the locations of all of the playgrounds that are nearby George's house and to which Fluffy enjoys going to visit with his dog buddies. Other dog owners could do the same with respect to their dogs. When one of the owners decides to take her dog to one of the playgrounds, she could note that fact on the technology and that information could be provided to the other owners (for example through a social networking site or by e-mail or by text message), and in some respects to the dogs, that are in the neighborhood of that playground. For example, the technology could tell George that Muffy, a dog buddy of Fluffy, will be at the Lincoln playground at the corner of Main and Willoughby at three o'clock in the afternoon. This message could be sent to George on his mobile phone at the office. George could then reply with a message to cause the technology to tell his daughter, who is at home, to take Fluffy to the Lincoln playground to visit with Muffy at 3 PM. In addition, or alternatively, the technology could cause an artifact to be played on the sound system in George's house to attract Fluffy to watch the TV monitor. Then a picture of Muffy romping at the Lincoln playground, and previously captured, could be displayed to Fluffy. Fluffy could then step on a switch to indicate that she wants to go to the Lincoln playground to play with Muffy. This artifact would trigger an alert to George's daughter, who could then take Fluffy to the Lincoln playground.

In another example, a dog or cat could be attracted to a location to initiate interaction by using any kind of device or mechanism that can provide an artifact that is attractive to the animal. The artifact could be an odor as animals are often highly sensitive to odors and attracted by them. A device or mechanism capable of emitting an odor in response to a command could be provided. (See for example the discussion at http://en.wikipedia.org/wiki/Digital_scent_technology.) By coordinating the emitting of the odor with, for example, the beginning of a video presentation, the animal could be attracted to watch the video presentation. In some instances, the device or mechanism could be one that provides vibrations or other tactile artifacts in response to a command. Animals are often sensitive to and attracted by sounds and physical sensations. The initiation of the associated video (or any other artifact or communication to be presented to the animal) could be delayed until a sensor determines that the animal is in the vicinity of the television or other device that is presenting the artifacts. That is, the sequence could be first to command the release of the odor or vibration, next to monitor for the presence of the animal, and finally to initiate the presentation of the artifacts.

For a given animal and for multiple animals, the databases can store information about and examples of behavior, size, age, species, ownership, location, favorite foods, relationships and friendships among different animals, and associations of animals with humans, among other things.

The databases can include information about communications and artifacts of communication associated with individual animals or groups of animals and individual humans or groups of humans. The artifacts can be associated in the database with interpreted communications that relate to the artifacts. Conversely, the database can store communications that might occur or that the user might wish to occur and could associate those communications with artifacts that can be used to convey them.

For example, a standard communication that George might want to convey to Fluffy would be “You may now go out of the house by stepping on the switch that opens the gate at the front door.” The related artifact might be turning on a signal light on the gate. The database could store the communication and associated with an action to be performed by a client device, namely turning on the light. During operation, George might choose, through an interface on a telephone, an entry that said “Fluffy, it's okay to go out of the house.” When that selection is received by the server, the server could use the database to associate it with the action of turning on the light. The server would then send an instruction to a client device at the house causing the light to be turned on.

Conversely, Fluffy may miss George and want to see live streaming video of George at work. Fluffy could step on the switch three times as an artifact to signal this message. George, at work, could turn on the camera of his mobile phone and allow it to capture video which would then be streamed to the television and George's living room for Fluffy to watch.

The technology 30 can be used in a wide variety of situations to assist humans to communicate with animals. We describe several additional examples below, but these are merely a few examples of thousands of possible cases.

1. A cat owner is at work. The owner has left her cat, Buffy, at home alone for the day. At lunchtime, the cat owner is wondering how Buffy is faring. The cat owner uses an app on her mobile phone to connect to the server of the technology 20. The app displays a user interface screen on which the cat owner can select “Check in on Buffy.” The server then sends instructions to a client device in the form of a laptop sitting on the dresser in the room where Buffy is spending the day. The instructions cause the laptop to turn on the camera of the laptop and begin to stream video of Buffy to the server, which then streams it to the owner's phone. The video shows that Buffy is running around in a circle licking her lips. At the same time, based on previously recorded videos of Buffy and information previously entered by the owner about the meaning of those recorded videos, the interpreter at the server determines that Buffy is hungry. The server causes the owner's mobile phone to display a message underneath the streaming video that says “Buffy is hungry.” This is the interpreted message from the artifact of Buffy running around in a circle and licking her lips. The message confirms to the owner the owner's guess that Buffy is hungry based on watching the streaming video. Next, the server can send an instruction to the owner's mobile telephone to cause it to provide a dialogue that asks “Do you want Buffy to be fed?” If the owner's replies that she does, that communication is articulated at the server, using the database, into artifacts to be executed to enable Buffy to be fed. For example, the server can send a video back to the laptop to be displayed to Buffy that displays a symbol or a video of the owner or some other artifact that Buffy has come to know as the signal that she can feed herself from a storage container in the room. In this example, Buffy has been trained or preconditioned to behave in a certain way when certain artifacts are presented to her from client devices. Buffy then goes to the storage container on the floor of the room which has now been conditioned by an electronic switch to be accessible. Buffy opens the storage container and eats the food. The laptop can stream video to the server and the server can stream the video to the owner's mobile phone showing that Buffy is eating.

Throughout our discussion, although we have referred to communications based on the English language, of course, any language could be the medium of communication, including signed language for the deaf.

Although we provide some specific examples in our discussion, the concepts that underlie the examples can be applied to a wide variety of other implementations. For example, the animals need not be dogs or cats or even pets. Any animal capable of some level of communication could be involved. The human and animal need not be in different locations and need not be unable to see or hear each other in some implementations. They can be in the same place and able to see or hear each other and still be benefited by assisted communication of the kind that we describe. In some applications, the assisted communication can be between one animal and another animal without a human involved.

Other implementations are within the scope of the following claims.

1. A method comprising
receiving artifacts of a communication from the animal through interface features of one or more devices, and
interpreting the artifacts by computer to derive an interpreted communication represented by the artifacts.

2. The method of claim 1 in which receiving the artifacts of the communication includes detecting at least one of a noise or motion of the animal.

3. The method of claim 1 in which interpreting the artifacts comprises comparing the artifacts to known examples of similar artifacts.

4. The method of claim 1 in which interpreting the artifacts is done at a server.

5. The method of claim 1 in which interpreting the artifacts is done at a client device.

6. The method of claim 1 in which interpreting the artifacts includes using information provided by a human being about the animal or about artifacts that may be produced by the animal.

7. The method of claim 1 comprising presenting the interpreted communication to a human being.

8. The method of claim 7 in which the animal and the human are at different locations.

9. The method of claim 7 in which the animal is a pet and the human is the pet's owner.

10. The method of claim 7 in which the interpreted communication is presented to the human being through a user interface of the device.

11. A method comprising
receiving a communication from a human to an animal through interface features of one or more devices, and
articulating the communication by computer as artifacts that will represent the communication when presented to the animal.

12. The method of claim 11 in which the communication is expressed in a form that is understandable by humans but not understandable by an animal.

13. The method of claim 11 in which the communication is received as text or speech from the human.

14. The method of claim 11 in which the one or more devices comprise a mobile device.

15. The method of claim 11 in which the communication is articulated as the artifacts based on information provided by humans about the relationship of the communication to the artifacts.

16. The method of claim 11 comprising causing the artifacts to be presented to the animal.

17. The method of claim 16 in which the artifacts are caused to be presented to the animal by interface features of one or more devices.

18. The method of claim 16 in which the artifacts are caused to be presented to the animal by sending them through a network to one or more devices located with the animal.

19. The method of claim 11 in which the human and the animal are in different locations.

20. A method comprising
receiving at a server from one or more client devices, artifacts of communications of animals through interface features of one or more devices, and
sending from the server to one or more client devices, information that enables the one or more client devices to convey the communications to human beings.

21. The method of claim 20 comprising
interpreting the artifacts to derive the communications.
